(19) United States
(12) Patent Application Publication
(10) Pub. No.: US 2026/0336255 A1
(43) Pub. Date: Oct. 29, 2026

(54) MULTISTABLE MORPHING SURFACE FOR INTERACTIVE RECONFIGURATION

(71) Applicant: Purdue Research Foundation, West Lafayette, IN (US)

(72) Inventors: Andres Felipe Arrieta Diaz, West Lafayette, IN (US); Jhonatan Steven Rincon Angarita, Lafayette, IN (US); Juan Camilo Osorio Pinzon, Lafayette, IN (US)

(73) Assignee: Purdue Research Foundation, West Lafayette, IN (US)

(21) Appl. No.: 19/659,968

(22) Filed: Apr. 27, 2026

Related U.S. Application Data
(60) Provisional application No. 63/794,658, filed on Apr. 25, 2025.

(51) Int. Cl. B32B 3/30; B32B 27/08; B32B 27/40

(52) U.S. Cl. CPC B32B 3/30; B32B 27/08; B32B 27/40

(57) ABSTRACT

A morphable metasheet structure may include a sheet defining an internal channel; and an array of mechanically multistable units protruding from the sheet. Each mechanically multistable unit may be reversible between at least two mechanically stable configurations and define one or more internal cavities. After a mechanically multistable unit transitions to one of the mechanically stable configurations, the mechanically multistable unit remains in the mechanically stable configuration in the absence of continued pneumatic pressurization. The internal channel may fluidly connect at least some of the mechanically multistable units to one another.

### CROSS REFERENCE TO RELATED APPLICATIONS

This application claims the benefit of U.S. Provisional Application No. 63/794,658 filed Apr. 25, 2025, the entirety of which is hereby incorporated by reference.

### GOVERNMENT RIGHTS

This invention was made with government support under 1944597 awarded by the National Science Foundation. The government has certain rights in the invention.

### TECHNICAL FIELD

This disclosure relates to morphing surfaces and, in particular, to open-loop morphing surfaces.

### BACKGROUND

Structures capable of undergoing controlled shape changes have been developed for use in a variety of mechanical and structural applications, including adaptive surfaces, compliant mechanisms, and morphing structures. In many such systems, shape change is produced through mechanical deformation induced by external actuation, such as pneumatic, hydraulic, thermal, electrical, or magnetic actuation.

Some morphing structures employ mechanical elements that exhibit multiple mechanically stable configurations, such that discrete shape changes may be obtained through transitions between stable states. In these systems, transitions may occur through snap-through or buckling phenomena, and a selected configuration may persist after an actuation input is removed. Mechanical multistability has been incorporated into various structural forms, including shells, plates, beams, and compliant mechanisms, and has been explored in combination with different actuation modalities.

Pneumatic actuation has also been applied to morphing and morphable metasheet structures by introducing pressurized fluid into internal cavities, chambers, or channels formed within or adjacent to deformable structural elements. Depending on the configuration, pneumatic systems may employ external control hardware, such as valves, manifolds, or regulators, to direct pressurized fluid to selected regions of a structure. In some arrangements, pressurization may be applied sequentially or selectively to different portions of a structure to induce localized deformation.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The embodiments may be better understood with reference to the following drawings and description. The components in the figures are not necessarily to scale. Moreover, in the figures, like-referenced numerals designate corresponding parts throughout the different views.

FIG. 1 illustrates an example of a metasheet structure.

FIG. 2 illustrates a second example of the metasheet structure.

FIG. 3 illustrates an example of a metasheet structure which includes a strip of multistable units.

FIG. 4 illustrates a perspective view of a metasheet structure after actuation of some multistable units.

FIG. 5 illustrates an example of the metasheet structure where unit inversion sequence control is achieved through parameterization.

FIG. 6 illustrates an arrangement of multistable units in a diamond shape.

FIG. 7 illustrates an arrangement of multistable units in a square shape.

FIG. 8 illustrates an arrangement of multistable units in a hexagonal shape.

FIG. 9 illustrates an example of a metasheet structure with multiple pneumatic inlets (P1-P9) controlling separate zones.

FIG. 10 illustrates an example of a system to control the actuation of the metasheet structure.

### DETAILED DESCRIPTION

Morphing structures and materials, with their ability to dynamically transform shape, have introduced a new design strategy for advanced and intelligent systems. Unlike traditional components bound to fixed configurations, morphing systems offer unparalleled adaptability, enabling efficient operation across diverse conditions. By using architectures composed of carefully arranged elemental units, these systems can achieve functionalities that exceed those of their individual constituents. This adaptability has already demonstrated transformative potential in a range of applications, including smart textiles that respond to environmental conditions, medical devices with shape-shifting capabilities for minimally invasive procedures, and foldable shelters designed for rapid deployment in disaster zones.

Multi-stability has emerged as a promising approach for addressing these challenges by enabling systems to transition between discrete, stable configurations while inherently providing self-locking capabilities. Existing approaches rely on continuous actuation to achieve and maintain their shapes. Because these systems are composed of individual units, their global behavior—defined by multiple stable states—can be accessed through selective activation of those units, such as snap-through events. As a result, all stable states of the structure can be reached through an appropriate activation sequence. This characteristic allows morphing systems to achieve reversible shape transformations without requiring constant energy input, making them particularly attractive for scalable applications.

Despite these advantages, current multistable implementations come with important limitations. In particular, the use of discrete stable configurations eliminates access to a continuous configuration space, restricting the system to a predefined set of shapes. Additional challenges include limited deformation capacity, unintended interactions between stable states, and the loss of specific configurations when systems are scaled. Moreover, most multistable structures exhibit geometrically simple shapes due to their nearly zero Gaussian curvature, resulting in curvature variation that is largely confined to a single coordinate direction. The typically small number of stable states—often limited to two—and the low geometrical complexity of these structures represent significant barriers to widespread adoption. Fully unlocking the potential of multistable systems will require the integration of innovative fabrication techniques and responsive materials, creating new opportunities for adaptable, high-performance morphing structures.

Accordingly, this disclosure provides various technical advances over existing approaches. By way of introductory example, a morphable metasheet structure may include a sheet defining an internal channel and an array of mechanically multistable units protruding from the sheet. The multistable unit may be reversible between at least two mechanically stable configurations and defining one or more internal chambers. After a multistable unit transitions to one of the mechanically stable configurations, the multistable unit remains in the mechanically stable configuration in the absence of continued pneumatic pressurization. The internal channel may fluidly connect at least some of the mechanically multistable units to one another.

Unlike inflatable membranes or continuously deformable pneumatic bladders, the disclosed mechanically multi-stable units undergo snap-through transitions between discrete stable states, providing inherent mechanical locking independent of sustained pressurization. Depending on the implementation, the morphable metasheet may exhibit several geometrically complex shapes accessible via open-loop control inputs. This compliant sheet includes a patterned array of bistable dome shape units that exhibit multiple energy minima once they are patterned to guarantee unit interaction. This disclosure provides a pneumatic actuation design that is geometrically optimized to reduce its effect on the metasheet, which ensures that the multistable and morphing capabilities of the structure are retained while guaranteeing actuation via inflation. This disclosure also provides various control strategies using geometrical features of the structure and air channel arrangements, which enables unit inversion control, thus reducing the number of air inlets while retaining multiple stable states. Moreover, this disclosure explores the effect of the global shape of the morphing surface on the number of global shapes and morphing modes, showing the final shape of the system is determined by both the local shape of the unit and the shape of the free boundary. In addition, this disclosures provides an open loop control strategy based on the mechanical response of the structure by utilizing sequential actuation to attain different final configurations with specific and unique input sequences. The geometrical complexity, rich configuration space, and simple actuation of the presented multistable metastructures provide a promising blueprint for the design of functional morphing structures.

Although certain illustrated embodiments employ bistable dome-shaped shell elements, mechanically multistable units as used herein include elements having two or more mechanically stable configurations. The disclosed dome structures are representative examples, and other geometries capable of exhibiting multiple mechanically stable configurations may be used.

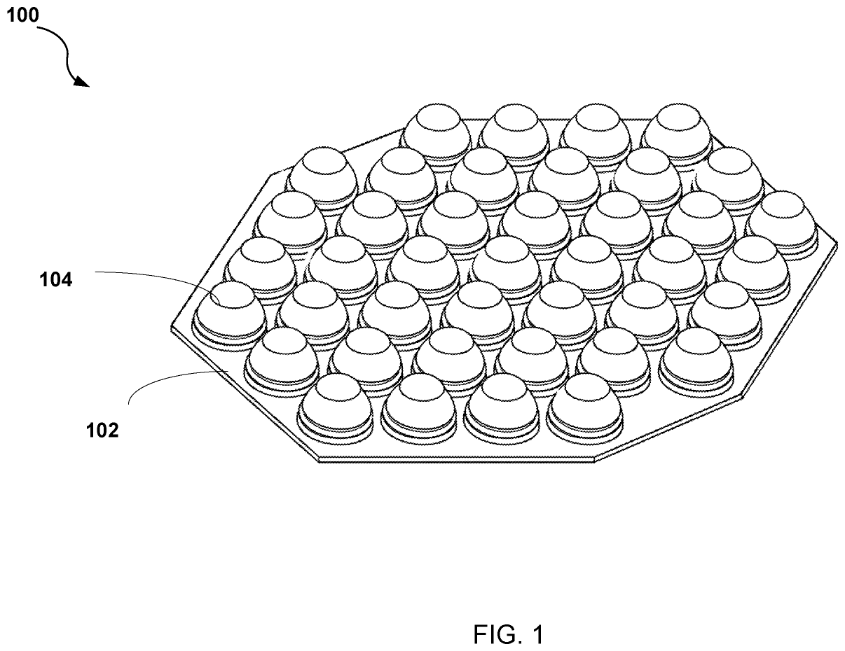

FIG. 1 illustrates an example of a metasheet structure 100. The metasheet structure 100 may include a sheet 102 and multistable units 104 which protrude from a surface of the sheet 102. The multistable units 104 may have at least two mechanically stable configurations. The multistable units 104 may be reversible such that they are actuated between one of two states. The multistable units 104 may remain in a mechanically stable configuration in the absence of continued pneumatic pressurization. The multistable unit 104 may be connected one or more other multistable units on the sheet via an internal channel defined in the sheet 102.

As used herein, the term “sheet” refers broadly to a structural body that extends in two lateral dimensions and provides a continuous or substantially continuous support or substrate for other elements of the morphable metasheet structure.

In some embodiments, the sheet comprises a thin, plate-like, or membrane-like structure having a thickness that is small relative to its lateral dimensions, and configured to support an array of mechanically multistable units. The sheet may be planar, curved, or geometrically contoured, and may be configured to deform, flex, or remain substantially rigid unless fully actuated.

In more specific embodiments, the sheet includes internal channels, cavities, or conduits formed within the thickness of the sheet, such that the sheet functions as both a structural substrate and a fluidic distribution layer for pneumatic pressurization of the mechanically multistable units. The sheet may be monolithic with the mechanically multistable units or may be formed integrally with the units during fabrication, for example by additive manufacturing, molding, or lithographic processes.

The sheet 102 may further be configured to transmit mechanical loads between mechanically multistable units, to constrain or guide deformation of the units, and/or to define boundary conditions that influence the stable global configurations of the morphable metasheet structure.

By way of non-limiting example, the sheet 102 may be formed from polymeric materials (including elastomers, thermoplastics, or thermosets), composite materials, metallic materials, ceramic materials, or combinations thereof. In certain embodiments, the sheet may be fabricated from silicone elastomers, polyurethane, nylon, polyethylene, polypropylene, epoxy-based composites, carbon-fiber-reinforced polymers, metallic foils, or layered or graded material systems.

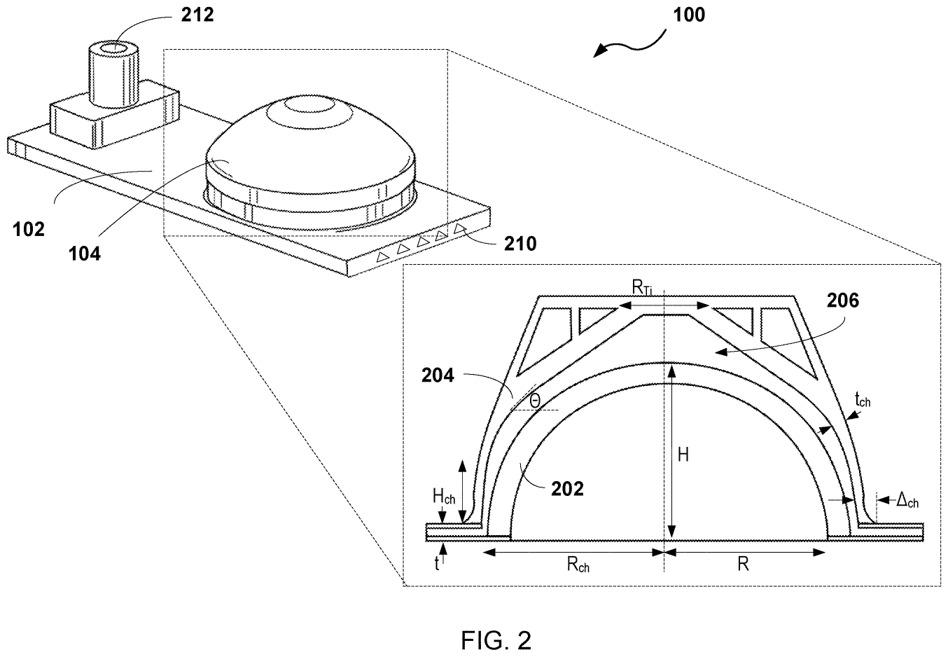

FIG. 2 illustrates a second example of the metasheet structure 100. Only one multistable unit 104 is visible in FIG. 2, though the metasheet structure 100 may have additional multistable units which are not shown. The metasheet structure 100 may include a multistable morphing structure and a pneumatically actuated patterned array of multistable units in a continuum metasheet.

By way of example, the multistable unit may include an inner shell 202 and an outer shell 204. The inner shell 202 and outer shell 204 may define a chamber 206 which is a space between the shells that may receive fluid (liquid or gas). Inflating the chamber 206 may cause the inner and/or outer shell to buckle. For example, the inner dome may bounce outwards away from the outer shell. Alternatively or in addition, the inner shell 202 may invert with respect to the plane of the sheet 104.

In some examples, the inner shell 202 and outer shell 204 may be dome structures. As illustrated in FIG. 2, the dome is modeled as a hemispherical geometry with base radius R, height H, and thickness t. These parameters control the dome stability on the second stable state, the amount of pressure required to invert the dome, and the stored energy. On the other hand, the pneumatic chamber geometry is designed to enhance the dome behavior while considering the manufacturing aspects. To achieve this, the chamber is designed by combining a concave surface on the bottom connected to the dome base and a conic section that encloses the dome geometry. The concave surface on the base of the pneumatic chamber (described by H_{ch} and Δ_{ch}) acts as a pre-buckle membrane that decreases the bending resistance imposed by the chamber. By using this, less energy from the dome inversion is utilized to deform the actuation system, and more is transferred to the rest of the structure. The rest of the chamber is designed by considering manufacturing aspects, such as printability and air tidiness, which are determined by the chamber conic section angle (θ) and the flat tip of the cone diameter (R_{Tip}). The proposed topology allows the dome's state to be switched between the as-manufactured (ground) and inverted (stressed) states by applying air pressure. As pressure is released, the bistable unit remains inverted, and strain energy is stored in the system. As units are combined into a continuous body, strain energy is stored at every inversion, which results in the global curvature of the meta, yielding all the possible, stable states of the system. Multistability and energy barriers between stable configurations of the structure are determined by dome geometry (dome height (H), Dome radius (R), Dome thickness (t)). By selecting geometric parameters of individual mechanically multi-stable units during fabrication, the metasheet is effectively programmed to exhibit a predetermined sequence of mechanically stable configurations when subjected to pneumatic pressurization.

The number of stable states and the magnitude of out-of-plane deformation are governed primarily by interactions among inverted units, which are defined by the unit-cell distance (UC), pneumatic chamber thickness (t_{ch}), chamber radius (R_{ch}), and base curvature (Δ_{ch}). In addition, the ability of the units to be arranged into different configurations is demonstrated by examining three distinct boundary shapes. The boundary geometry plays a critical role in determining the surface deformation modes of the structure; as the number of boundary edges increases, so does the number of preferred bending directions and, consequently, the number of attainable global stable shapes.

The multistable unit may have at least one inlet 208 and at least one outlet 210. The sheet may have internal channels which connect to the inlet and outlet respectively. The sheet may further include a pneumatic input by which pressure is varied. The pneumatic input may fluidly connect to the internal channels and/or chambers of the multistable units. Engaging the pneumatic input with pressurized fluid may cause actuation of the multistable units,

The sheet 102 may define internal channel(s) 210. The internal channels may fluidly connect the multistable units to a pneumatic inlet 212 and/or other multiscale units. The multistable units may be connected in patterns via the internal channel(s) 208 of the sheet. The internal channels 210 may take various cross sections. In some examples, the cross section may be a triangular geometry. A triangular channel geometry of the internal channels of the sheet facilitates a stable “bridging” mechanism when forming the upper channel surfaces, allowing consistent printing in flexible thermoplastic polyurethane (TPU) such as Ninjaflex 85A without compromising wall integrity. Previous research by Conrad et al.29 highlighted the difficulty of printing flat unsupported regions in soft robotic applications due to the poor bridging properties of flexible filaments, particularly the risk of sagging in overhang regions. The triangular profile mitigates these issues and ensures repeatable channel formation in a single uninterrupted print

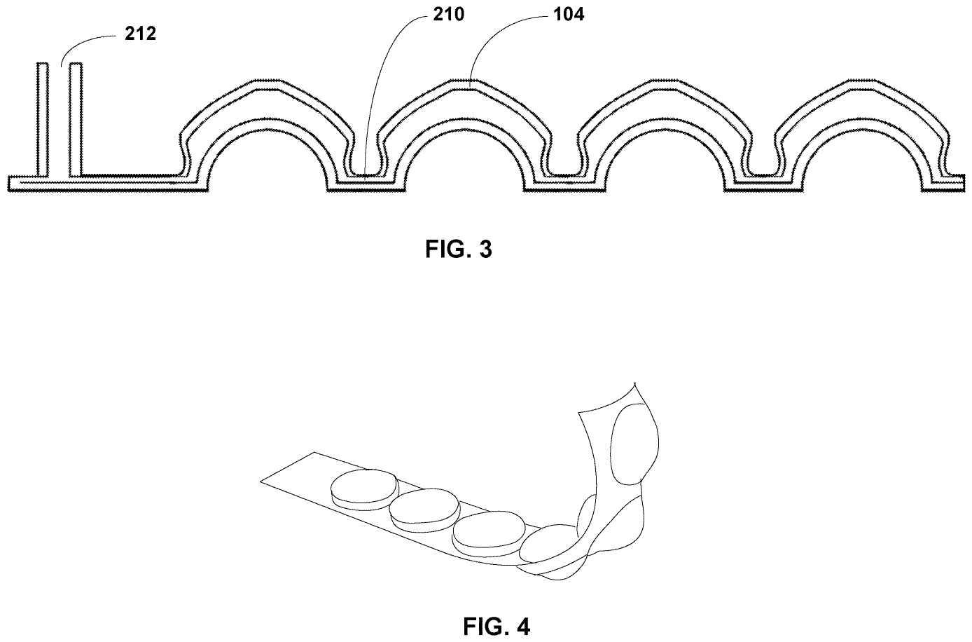

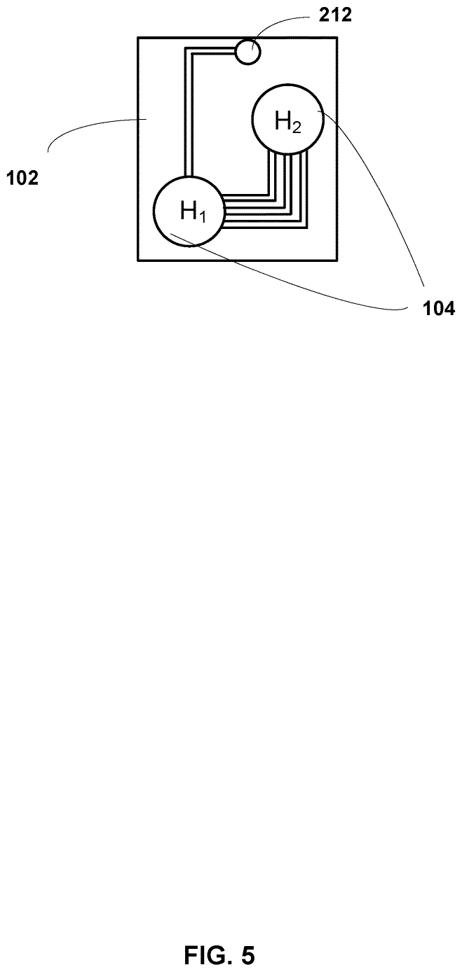

FIG. 3 illustrates an example of a metasheet structure which includes a strip of multistable units. In this example, the internal channels 210 may connect a series of multistable units 104. The pneumatic inlet 212 may actuate the multistable units. The timing and order of the actuation may vary depending on various factors including the dimensions, material, and other attributes of the multistable units and the internal channels between the multistable units. FIG. 4 illustrates a perspective view of the metasheet structure after actuation of some of the multistable units. The morphable sheet may curve up in response to the actuation.

In various experimentation, the configuration shown in FIG. 3 and FIG. 4 was assessed with variations to the properties the multistable units to evaluate the affect of the morphing capabilities of the strip. In one example, the dome pneumatic strip included a row of dome units arranged periodically with a uniform spacing between the units. Each dome unit shared an identical pneumatic chamber, and all chambers are interconnected through air channels embedded within the structure's thickness. Snap-through actuation is induced by applying a pressure load on the domes while the edges were pinned. To ensure quasi-static conditions, boundary conditions are released sequentially. After the domes invert and the structure stabilizes, the final curvature was measured by fitting a circle to the deformed shape.

Using the finite element method (FEM) parameter sweeps where performed to investigate the effect of the pneumatic chamber on strip behavior. One parameter sweep first explored the influence of geometric parameters of the dome unit and the pneumatic chamber on the final curvature of the strip. The tip radius (RTip) and conic section angle were kept constant due to their negligible impact on morphing behavior. To reduce bending resistance, the chamber thickness (tch) is minimized to the lowest printable value. Keeping the chamber parameters constant. Introducing the pneumatic chamber causes the curvature to depend on the thickness. As thickness increases, so does the strain energy within the system, enabling the structure to recover more curvature lost due to actuation. Furthermore, adding a pneumatic chamber near the dome affects its stability; in some cases, bistability is lost upon chamber introduction.

Another second parameter sweep examines the concave region parameter Δ_{ch} and the chamber's proximity to the dome (chamber radius R_{ch}). For H=6 mm and t=0.8 mm, increasing Δ_{ch} enhances the strip's curvature, suggesting that a more compliant membrane promotes morphing. Conversely, a smaller R_{ch} (closer chamber proximity to the dome) also increases curvature. However, the flat region cannot bend or stretch freely as the pneumatic chamber grows larger and occupies more of the unit cell (R_{ch}/UC≈1).

Based on these results, we optimize the chamber geometry to minimize curvature loss caused by the actuation system showing up to 90% of curvature recovery on the pneumatic strip. More importantly, we can retain some of the flat region buckling behavior, which is crucial when units are patterned in a 2D periodic array.

FIG. 5 illustrates an example of the metasheet structure where unit inversion sequence control is achieved through parameterization. The parameterized design provides selective interconnection among dome structures. By strategically positioning and branching the channels, the multistable structure can collectively group domes into discrete clusters that inflate or deflate through a dedicated inlet. This approach allows for multiple independent controllable zones without resorting to numerous external tubes or complex actuation systems. Moreover, taking advantage of the internal fluid routing opens the possibility of defining the actuation sequence of each dome based on dynamic air pressure: if all domes share the same dimensions, the dome nearest to the inlet will inflate first under higher local pressure, followed by those farther downstream. Therefore, this can be used to leverage the structure's order dependence for programming complex, programmed actuation behaviors within the metasheet. Alternatively, the dome height, or other physical aspects of the multistable unit shape, may be varied to change the order or timing in which inversion occurs.

Achieving monolithic components in soft robotics is advantageous, as it removes potential failure points at seams or connections. Accordingly, the metasheet 100 may be 3d-printed. Extrusion parameters and layer adhesion settings may be tuned to ensure the hermetic sealing of both the multistable unit chambers and the internal channels effectively preventing fluid leakage under high pressures. It is worth noting that although we have managed to seal the structure using this approach in our cases of interest, there are scenarios where very thin designs or excessive overhang can still result in small acceptable gaps. To reduce the effect of these gaps, we utilize a complementary post-processing method by applying a coating of Formlabs Flexible 80A resin diluted by 20% with acetone, which is subsequently cured under UV light.

In various experimentation, the multistable structure utilized Ninjaflex 85A TPU to balance ductility and resilience. Its elongation properties allow repeated inflation cycles without cracking, and its Shore hardness enables thin-walled sections to flex properly, allowing for dome and channel deformation. Notably, wall features on the order of 0.4 mm and channel heights of approximately 0.7 mm can be printed reliably, illustrating how fused filament fabrication (FFF) can handle intricate geometries that traditional silicone casting methods would struggle to replicate. The metastable structure consistently withstood internal pressures of up to 50 psi without leakages, demonstrating the robustness of both the flexible TPU material and the monolithic sealing approach. Although additional burst-pressure tests could confirm even higher safety thresholds, these results already suffice for many soft robotic actuation scenarios with moderate internal pressures. Combining a single-print process, triangular channels, and parameterized dome interconnection highlights a versatile strategy for creating multi-zone actuation in soft metasheets while simplifying assembly and preserving mechanical performance.

Also, in various experimentation, programming the inversion sequence by adjusting the dome height and thickness (H and t) was explored. By tuning these parameters, multiple stable or metastable states can be engineered within a single metasheet. For instance, assigning dome heights of H=4.0 mm, H=4.5 mm, and H=5.0 mm enables sequential snap-through events under progressively higher internal pressures. In comparison, shorter domes (H=3.0 mm) might exhibit transient, time-dependent metastable behaviors before reverting to the default state. This approach obviates the need for external mechanical constraints or control mechanisms as the dome geometry sets the actuation hierarchy. Consequently, a single pressure input induces a predictable cascade of dome inversions dictated by each dome's respective threshold. Once a dome inverts, its internal geometry stabilizes in the inverted position, establishing a new equilibrium until the pressure either increases to drive the next dome's inversion or decreases to allow snap-back.

In some embodiments, pneumatic pressurization is applied in a monotonically increasing manner such that mechanically multi-stable units having lower snap-through pressure thresholds transition prior to units having higher snap-through pressure thresholds, thereby producing a predetermined inversion sequence without requiring external sensing or feedback. For example, the actuation sequence is defined by the geometric properties of the mechanically multi-stable units established during fabrication, rather than by a programmable controller, software logic, or closed-loop feedback system.

When the arrangement of domes is extended into a continuous two-dimensional array, the number of possible global configurations increases significantly due to the independent bistable behavior of each dome. One could imagine 2n stable states for n domes. However, interactions between adjacent domes—facilitated by the flat regions connecting them—generate multiple stable states. These interactions lead to hierarchical multi-stability, where the global shape depends on the number of inverted domes and the specific sequence of inversions. Consequently, the same number of inverted units can yield distinct final geometries depending on the order in which they are manipulated

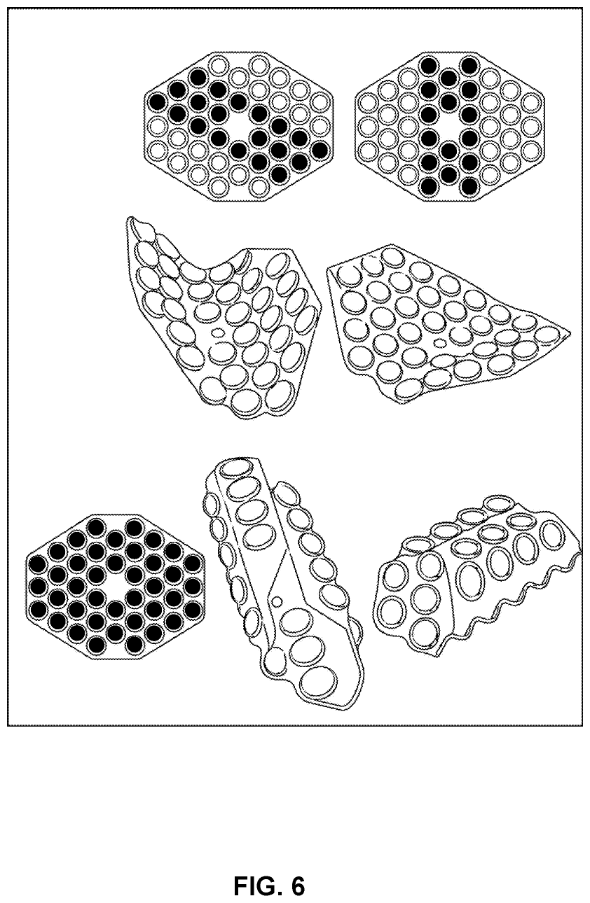

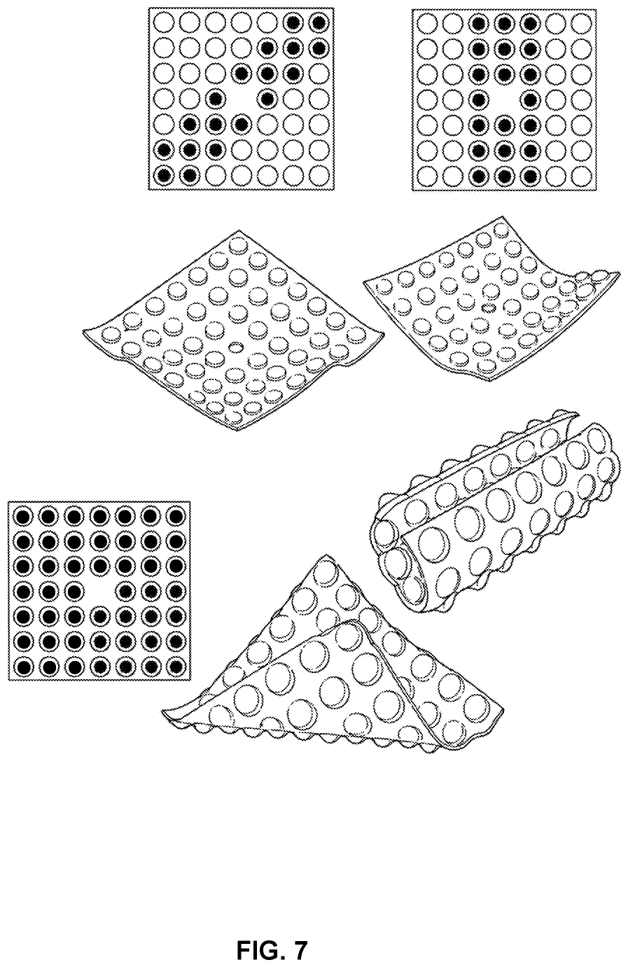

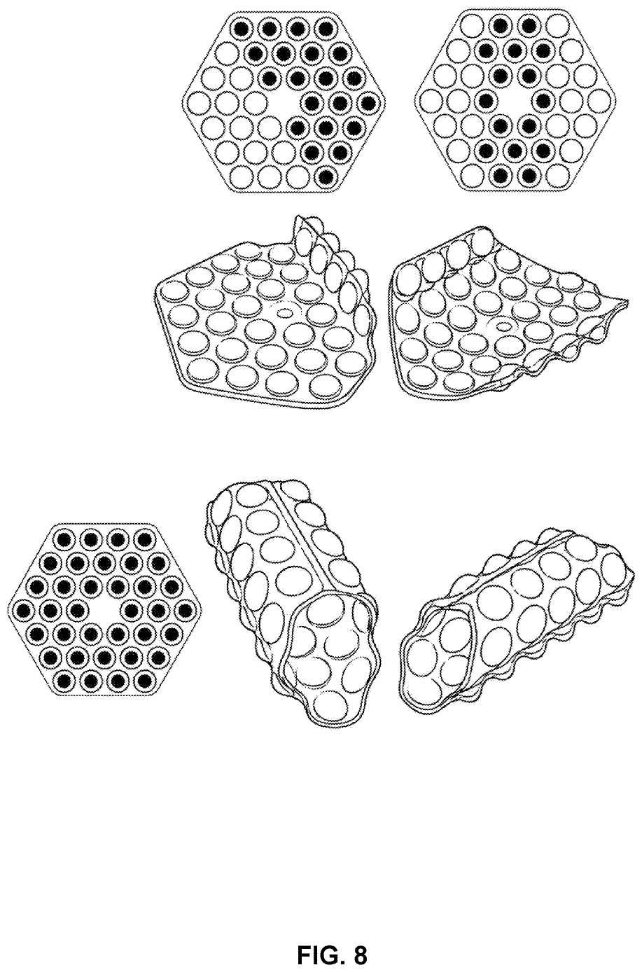

FIGS. 6-8 illustrates examples of the metasheet with pneumatic actuation, where different stable states emerge from the arrangement of dome units and the overall geometry. FIG. 6 illustrates an arrangement of multistable units in a diamond shape. The diamond-boundary layout employs a hexagonal lattice (the densest packing of circular elements in 2D), naturally channels bending lines along preferred directions, such as the diagonals or the midline, so that local dome inversions produce structured and stable curvatures. FIG. 7 illustrates an arrangement of multistable units in a square shape. A square lattice permits multiple bending directions, including principal axes and diagonals. Depending on the inversion sequence, specific curvature arises, defining rows, diagonals, or more intricate paths. FIG. 8 illustrates an arrangement of multistable units in a hexagonal shape. The hexagonal array layout is based on a hexagonal lattice but rotated 90°—promotes bending lines at 60° intervals, providing high symmetry and enables multiple oblique bending routes.

These lattice (and other) geometries and their respective boundary shapes strongly influence how curvature develops across the metasheet. For example, a higher density of domes along one diagonal in the diamond arrangement facilitates bending in that direction. Despite the differences in boundary shape and dome distribution, all these configurations share the ability to reconfigure into complex shapes without requiring continuous external energy. In each case, the pattern of inverted domes enforces specific curvatures. It thus defines stable, low-energy global geometries, allowing the metasheet to transition among various shapes through relatively simple inversion sequences.

Moreover, partial dome inversions in any of these arrangements modify the local stress state and shift inversion thresholds in neighboring regions, resulting in stable intermediate shapes. This elastic frustration can yield coexisting states that become “locked in” once a particular sequence of inversions has been established, underscoring the strong sequence dependence of the final geometry. The interplay of local bi-stability, boundary-driven constraints, and multidirectional bending lines thus enables a broad range of stable configurations without the need for continuous energy input, highlighting the potential of dome-patterned metasheets for robust and versatile morphing applications.

### Mechanical Based Open-Loop Control

Using the metasheets for multiple stable states and actuation/inversion path dependency, we can create pneumatic actuation strategies that do not rely on continuous feedback. The array of multistable unit may be divided into several actuation groups, each with a dedicated pneumatic inlet, that promote specific bending lines. This approach enables targeted pressurization of specific regions, permitting multiple intermediate shapes to be explored while requiring far fewer valves than the fully independent scenario.

In experimentation, a diamond-based morphing surface with three actuation zones was explored which could exhibit up to ten different stable states, with two coexisting final shapes. In such examples, every state can be accessed by a specific inversion sequence where each intermediate state (Si) is stable and can be utilized without any constant energy input. This capability can be especially valuable when only partial geometry changes are needed, such as creating a localized bulge or selective curvature along an edge or diagonal. Further subdividing the dome array can increase the number of achievable final shapes for applications that demand even more stable outcomes.

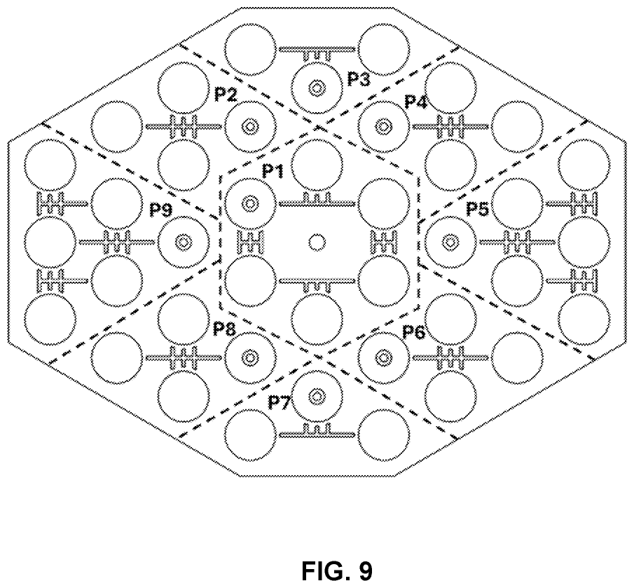

FIG. 9 illustrates an example of a metasheet structure with multiple pneumatic inlets (P1-P9) controlling separate zones, or groups, of the sheet. Each zone has at least one multistable unit which are fluidly connected dedicated network of internal channels. The internal channels for each zone connect the mutlstable units to the pneumatic input or are connected to one or more interveining multistable units which are actuated by the pneumatic input. Each of the zones may be independently actuated. It should also appreciated that the physical aspects of each multistable unit and internal channels in each zone may be varied such that multistable unites in a given zone invert in a particular order. Alternately, the multistable units and or internal channel may be uniform actuation may occur simultaneously.

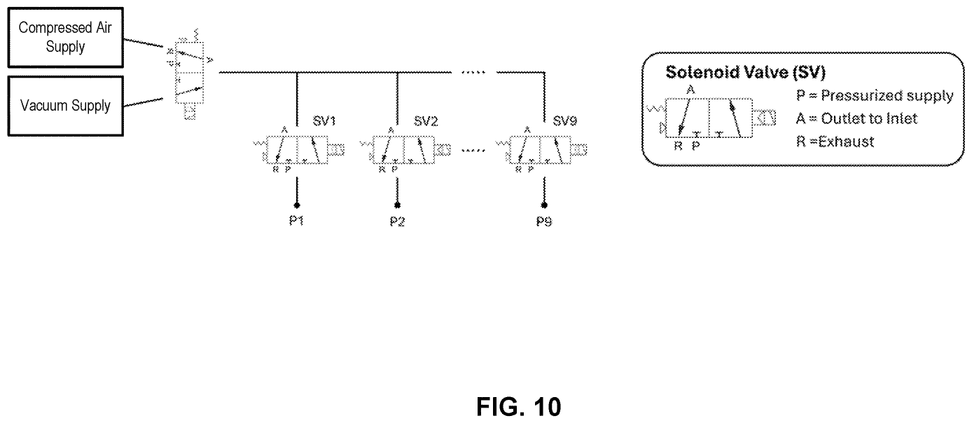

FIG. 10 illustrates an example of a system to control the actuation of the metasheet. In this embodiment, each solenoid valve (SV1-SV9) independently connects its associated inlet either to a compressed air supply (to induce dome inversion) or to a vacuum supply (to reset the domes). This configuration enables independent and selective actuation of each zone while maintaining a shared pressure/vacuum infrastructure. In some examples, a valve at may select the compressed air supply and/or the vacuumed supply, and the valves for each zone may be selectively controlled.

The system may be implemented in many ways. For example, each zone may have its own dedicated compressed air supply and/or vacuum supply. Alternatively or in addition, some zones may be applied positive pressure while other zones simultaneously receive negative pressure.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

While various embodiments have been described, it will be apparent to those of ordinary skill in the art that many more embodiments and implementations are possible. Accordingly, the embodiments described herein are examples, not the only possible embodiments and implementations.

What is claimed is:

1. A morphable metasheet structure, comprising:
a sheet defining an internal channel;
an array of mechanically multistable units protruding from the sheet, each mechanically multistable unit being reversible between at least two mechanically stable configurations and defining one or more internal cavities;
wherein, after a mechanically multistable unit transitions to one of the mechanically stable configurations, the mechanically multistable unit remains in the mechanically stable configuration in the absence of continued pneumatic pressurization; and
wherein the internal channel fluidly connects at least some of the mechanically multistable units to one another.

2. The morphable metasheet structure of claim 1, wherein different stable configurations of the morphable metasheet structure result from an order in which the mechanically multistable units transition between mechanically stable configurations under pneumatic pressurization.

3. The morphable metasheet structure of claim 1, wherein the morphable metasheet structure is capable of assuming a plurality of stable global configurations, including at least one intermediate stable configuration between an initial configuration and a fully actuated configuration, when pneumatically actuated through the internal channels.

4. The morphable metasheet structure of claim 1, wherein reversibility is achieved by transitioning the morphable metasheet structure through multiple mechanically stable global configurations under pneumatic pressurization applied through the internal channels, without elastic recovery upon depressurization.

5. The morphable metasheet structure of claim 1,wherein different mechanically multistable units transition between mechanically stable configurations at different pneumatic pressure thresholds when pressurized through the internal channels.

6. The morphable metasheet structure of claim 5,wherein the different pneumatic pressure thresholds are determined by geometric parameters of the mechanically multistable units.

7. The morphable metasheet structure of claim 6,wherein the geometric parameters comprise at least one of dome height, shell thickness, cavity volume, or curvature.

8. The morphable metasheet structure of claim 1, wherein a topology of the internal channels causes different mechanically multistable units to transition between mechanically stable configurations at different times when pneumatically pressurized through the internal channels.

9. The morphable metasheet structure of claim 8, wherein mechanically multistable units positioned closer to a pneumatic inlet transition before mechanically multistable units positioned farther from the pneumatic inlet.

10. The morphable metasheet structure of claim 1, wherein the mechanically multistable units and the internal channels together form a fluidic network that is pneumatically pressurizable through a pneumatic input.

11. The morphable metasheet structure of claim 1, wherein the mechanically multistable units and the internal channels together form a plurality of fluidic networks,
wherein each fluidic network is fluidically isolated from the other fluidic networks, and
wherein each fluidic network is pneumatically pressurized through a respective pneumatic input.

12. The morphable metasheet structure of claim 11, wherein pneumatic pressurization of each fluidic network produces a different stable global configuration of the morphable metasheet structure.

13. The morphable metasheet structure of claim 11, wherein selective pneumatic pressurization of one fluidic network relative to another fluidic network produces different stable global configurations of the morphable metasheet structure.

14. The morphable metasheet structure of claim 11, wherein each fluidic network corresponds to a different mechanically stable global configuration of the morphable metasheet structure when pneumatically pressurized.

15. The morphable metasheet structure of claim 11, wherein simultaneous pneumatic pressurization of more than one fluidic network produces a stable global configuration that is different from a configuration produced by pressurization of either fluidic network alone.

16. The morphable metasheet structure of claim 1, wherein the mechanically multistable units comprise curved shell structures configured to undergo snap-through instability.

17. A method actuating a morphable metasheet structure, comprising:
providing a metasheet comprising a sheet and an array of mechanically multi-stable units, wherein at least two mechanically multi-stable units differ in one or more geometric parameters selected from dome height, shell thickness, curvature, or internal cavity volume;
pneumatically pressurizing the mechanically multi-stable units through one or more internal channels; and
causing the mechanically multi-stable units to undergo snap-through transitions at different respective pressure levels determined by the geometric parameters,
such that a sequence of mechanically stable configurations is encoded in the geometry of the mechanically multi-stable units rather than in an external control system.

18. The method of claim 17, wherein the mechanically multi-stable units transition in a predetermined order under monotonically increasing pneumatic pressure due to the differing geometric parameters defining distinct snap-through pressure thresholds.

19. A method of selectively reconfiguring a morphable metasheet structure, comprising:
providing a metasheet having a plurality of mechanically multi-stable units arranged in a two-dimensional array and fluidly connected by internal pneumatic channels defining a plurality of fluidic networks;
selectively applying pneumatic pressurization to fewer than all of the fluidic networks;
causing mechanically multi-stable units within a pressurized fluidic network to transition to mechanically stable configurations while mechanically multi-stable units in unpressurized fluidic networks remain unchanged; and
thereby producing a selected global mechanically stable configuration of the metasheet based on which fluidic networks are pressurized.

20. The method of claim 19, wherein selectively applying pneumatic pressurization comprises independently pressurizing different fluidic networks in a predetermined sequence to generate different global mechanically stable configurations from the same metasheet structure.
